(19) United States
(12) Patent Application Publication
(10) Pub. No.: US 2017/0006785 A1
(43) Pub. Date: Jan. 12, 2017

(54) Bush and Shrub Protective Cover

(71) Applicant: PETER MAY, BARRINGTON, RI (US)

(72) Inventor: PETER MAY, BARRINGTON, RI (US)

(21) Appl. No.: 14/792,732

(22) Filed: Jul. 7, 2015

(51) Int. Cl. A01G 13/04; A01G 13/00

(52) U.S. Cl. CPC A01G 13/04; A01G 13/0225

(57) ABSTRACT

The bush and shrub protective cover is a structure that is adapted to protect landscaping against physical injury from harsh weather conditions including, but not limited to snow, ice, heavy rain, hail, and high winds. The bush and shrub protective cover comprises a plurality of legs, a top cap, and a plurality of sides. The plurality of legs form the base upon which the bush and shrub protective cover is built. The plurality of legs support the top cap and the plurality of sides. The top cap has holes that allow water to flow through the top cap to the protected plants. The top cap is also formed with grooves to route excess water away from the protected plants. Each of the plurality of sides is formed with a plurality of wind flaps to control air flow through the bush and shrub protective cover.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of plant husbandry and plant covers, shades, and screens, more specifically, a protective cover configured for use with bushes and shrubs.

### SUMMARY OF INVENTION

The bush and shrub protective cover is a structure that is adapted to protect landscaping against physical injury from harsh weather conditions including, but not limited to, protecting plants against snow, ice, freezing rain, hail, and high winds. The bush and shrub protective cover comprises a plurality of legs, a top cap, and a plurality of sides. The plurality of legs form the base upon which the bush and shrub protective cover is built. The plurality of legs support the top cap. The plurality of sides are also attached to the plurality of legs. The top cap has holes that allow water to flow through the top cap to the protected plants. The top cap is also formed with grooves to route excess water away from the protected plants. Each of the plurality of sides is formed with a plurality of wind flaps to control air flow through the bush and shrub protective cover.

These together with additional objects, features and advantages of the bush and shrub protective cover will be readily apparent to those of ordinary skill in the art upon reading the following detailed description of the presently preferred, but nonetheless illustrative, embodiments when taken in conjunction with the accompanying drawings.

In this respect, before explaining the current embodiments of the bush and shrub protective cover in detail, it is to be understood that the bush and shrub protective cover is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the bush and shrub protective cover.

It is therefore important that the claims be regarded as including such equivalent construction insofar as they do not depart from the spirit and scope of the bush and shrub protective cover. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is an in use view of an embodiment of the disclosure.

FIG. 3 is a detail view of an embodiment of the disclosure.

FIG. 4 is a top view of an embodiment of the disclosure.

FIG. 5 is a bottom view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

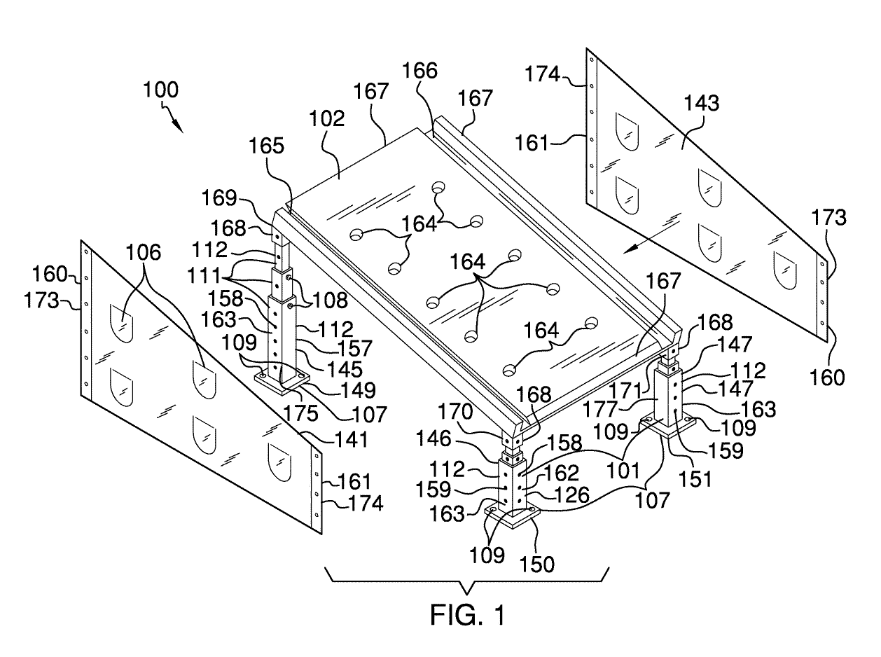

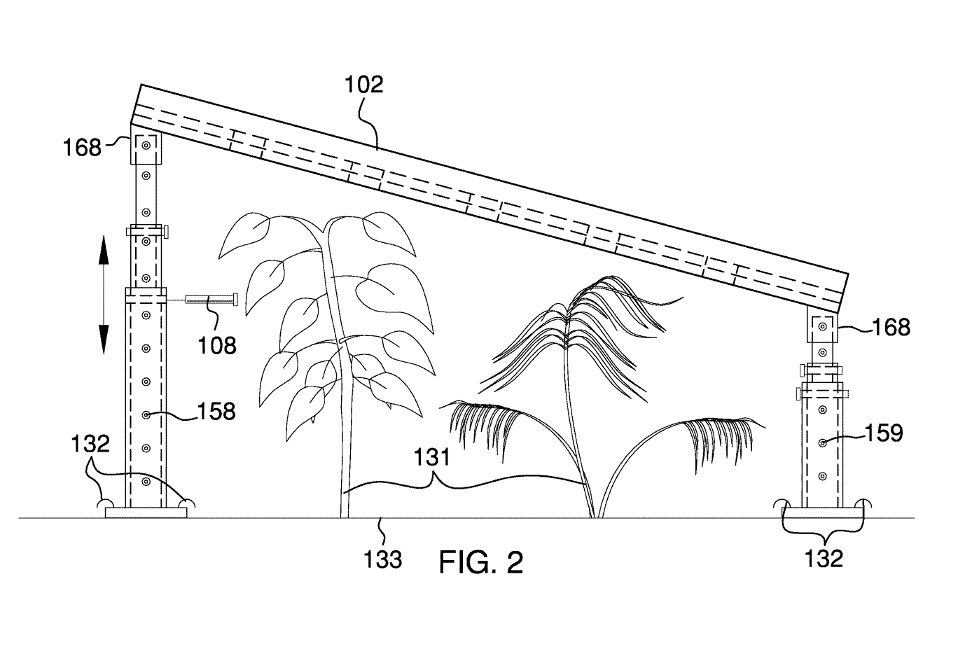

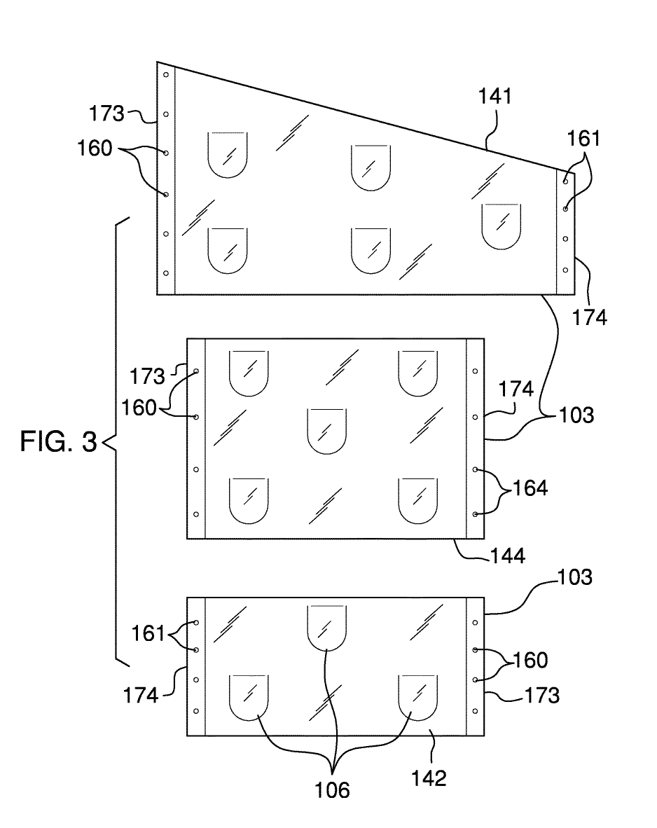

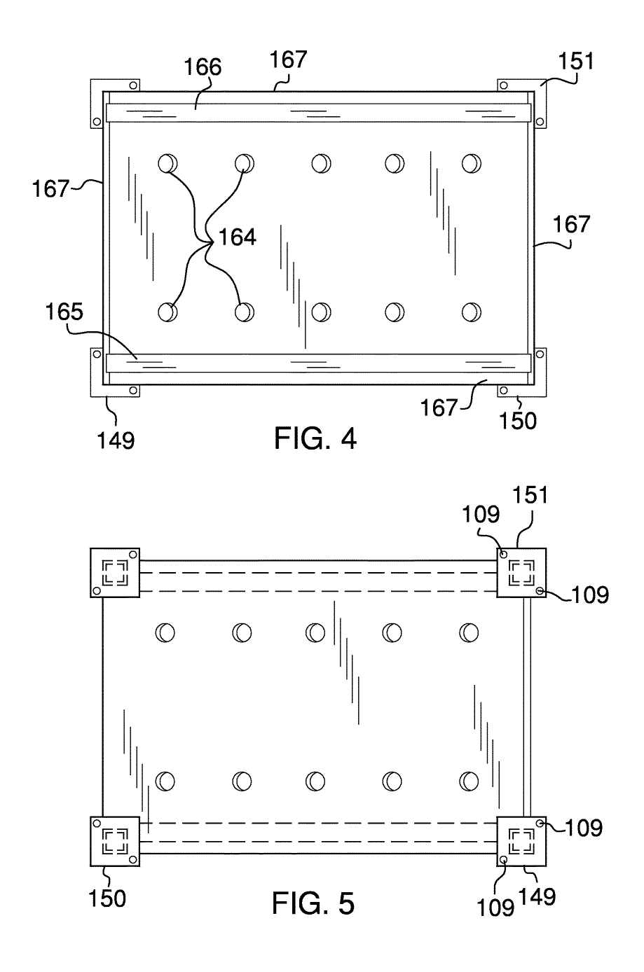

Detailed reference will now be made to a first potential embodiment of the disclosure, which is illustrated in FIGS. 1 through 5. The bush and shrub protective cover 100 (hereinafter invention) comprises a plurality of legs 101, a top cap 102, and a plurality of sides 103.

Each of the plurality of legs 101 is formed from a plurality of telescopic tubes 111. Each individual telescopic tube 112 is shaped in the form of a hollow rectangular block. There are two openings in each of the individual telescopic tubes 112. These openings are formed in the two surfaces of the individual telescopic tube 112 that have the minimum surface area. The plurality of telescopic tubes 111 are formed so that the plurality of telescopic tubes 111 can be nested into a telescopic arrangement. Specifically, the individual telescopic tube 112 with the smallest opening surface area is nested within the individual telescopic tube 112 with the second smallest opening surface area. This process continues until all the individual telescopic tubes 112 contained within the plurality of telescopic tubes 111 are nested within each other. Each individual telescopic tube 112 has formed in one of the sides that does not form the opening a seventeenth plurality of holes 157. Each of the seventeenth plurality of holes 157 formed in individual telescopic tube 112 are spaced at regular intervals and are formed to allow the seventeenth plurality of holes 157 formed in multiple individual telescopic tubes 112 to align when the multiple individual telescopic tubes 112 are nested.

The length of each of the plurality of legs 101 is controlled using the plurality of cotter pins 108. Specifically, the length of each of the plurality of legs 101 is set by holding an individual telescopic tube 112 selected from the plurality of telescopic tubes 111 in a fixed position relative to the remaining individual telescopic tubes 112 contained in the plurality of telescopic tubes 111. Each of the individual telescopic tubes 112 is fixed in position by aligning the seventeenth plurality of holes 157 formed in a first selected individual telescopic tube 112 with the seventeenth plurality of holes 157 formed in a second selected individual telescopic tubes 112 and then placing one of the plurality of cotter pins 108 through the aligned holes.

Of the three remaining sides of each of the individual telescopic tubes 112 after two sides with the openings and the side with the seventeenth plurality of holes 157 are eliminated, a twenty second side 162 and a twenty third side 163 are selected to receive an eighteenth plurality of female snap components 158 and a nineteenth plurality of female snap components 159 respectively. The eighteenth plurality of female snap components 158 and a nineteenth plurality of female snap components 159 are positioned such that they do not interfere with the nesting of the plurality of telescopic tubes 111. In the first potential embodiment of the disclosure, the eighteenth plurality of female snap components 158 and a nineteenth plurality of female snap components 159 are holes formed into the twenty second side 162 and a twenty third side 163.

The individual telescopic tube 112 with the largest opening surface area has an anchor plate 107 fastened over one of the openings. The anchor plate 107 is a rectangular plate that is larger than the surface area of the opening that the anchor plate 107 is covering. The anchor plate 107 has formed in it a plurality of anchor holes 109. Each of the plurality of anchor holes 109 are sized to receive a readily and commercially available tent peg 132 that can be used to anchor the anchor plate 107 to the ground 133 which in turn anchors the assembled plurality of telescopic tubes 111 to the ground 133.

The top cap 102 is a device that forms the top of the invention 100. The top cap 102 is formed as a plate. A twenty fourth plurality of holes 164 are formed through the two largest surfaces of the plate to allow water to flow through the top cap 102 into the interior of the invention 100 thereby providing water to the protected plants 131. The top cap 102 is also formed with a twenty fifth side channel 165 and a twenty sixth side channel 166. The purpose of the twenty fifth side channel 165 and a twenty sixth side channel 166 is to divert water away from the invention 100 to avoid the accumulation of standing water on the top cap 102. The perimeter of the surface of the top cap 102 distal from the ground 133 is formed with a twenty seventh lip 167. The twenty seventh lip 167 is a rim that is used to contain a moderate amount of water for use in watering the protected plants 131. The twenty seventh lip 167 has a passage way formed in it to allow the twenty fifth side channel 165 and a twenty sixth side channel 166 to divert water away from the invention 100. The surface of the top cap 102 that is proximal to the ground 133 is formed with a twenty eighth plurality of leg posts 168. Each of the twenty eighth plurality of leg posts 168 is sized to receive the individual telescopic tube 112 of each of the plurality of legs 101 that has the minimum surface area. By inserting each of the twenty eighth plurality of leg posts 168 into each of the plurality of legs 101, the top cap 102 is attached to the plurality of legs 101 and the basic structure of the invention 100 is formed.

Each of the plurality of sides 103 forms a side of the invention 100. Each of the plurality of sides 103 is made from plastic sheeting. Formed within each of the plurality of sides 103 is a plurality of wind flaps 106. The purpose of the plurality of wind flaps 106 is to control air flow through the invention 100. Each of the plurality of sides 103 is further formed with a thirty third side 173 and a thirty fourth side 174. The thirty third side 173 has attached to it the twentieth plurality of male snap components 160. The thirty fourth side 174 has attached to it the twenty first plurality of male snap components 161. Each of the twentieth plurality of male snap components 160 is sized to fit into the eighteenth plurality of female snap components 158. Each of the twentieth plurality of male snap components 160 is sized to fit into the eighteenth plurality of female snap components 158. Each of the plurality of sides 103 are attached to a first leg selected from the plurality of legs 101 and a second leg selected from the plurality of legs 101 such that the twentieth plurality of male snap components 160 snap into the eighteenth plurality of female snap components 158 associated with the first leg selected from the plurality of legs 101 and the twenty first plurality of male snap components 161 snap into the nineteenth plurality of female snap components 159 associated with the second leg selected from the plurality of legs 101.

To use the invention 100, the invention 100 is assembled and placed over the plants 131 that are to be protected.

The first potential embodiment of the disclosure is described and assembled as detailed below.

The plurality of sides 103 further comprises a first side 141, a second side 142, a third side 143 and a fourth side 144.

The plurality of legs 101 further comprises a fifth leg 145, a sixth leg 146, a seventh leg 147 and an eighth leg 148. The fifth leg 145 further comprises a thirty fifth plurality of telescopic tubes 175, a ninth anchor plate 149 and a thirteenth cotter pin. The sixth leg 146 further comprises a thirty sixth plurality of telescopic tubes 176, a tenth anchor plate 150 and a fourteenth cotter pin. The seventh leg 147 further comprises a thirty seventh plurality of telescopic tubes 177, an eleventh anchor plate 151 and a fifteenth cotter pin. The eighth leg further comprises a thirty eighth plurality of telescopic tubes, an twelfth anchor plate and a sixteenth cotter pin.

The top cap 102 further comprises a twenty ninth leg post 169, a thirtieth leg post 170, a thirty first leg post 171, and a thirty second leg post 172. The twenty ninth leg post 169 is inserted in the fifth leg 145. The thirtieth leg post 170 is inserted in the sixth leg 146. The thirty first leg post 171 is inserted in the seventh leg 147. The thirty second leg post is inserted in the eighth leg 148.

The first side 141 is attached to the fifth leg 145 and the sixth leg 146. The second side 142 is attached to the sixth leg 146 and the seventh leg 147. The third side 143 is attached to the seventh leg 147 and the eighth leg 148. The fourth side 144 is attached to the eighth leg and the fifth leg 145. The method of attaching each of the plurality of sides 103 to the plurality of legs 101 is discussed elsewhere in this disclosure.

The plurality of sides 103 can be formed from commercially available plastic sheeting including, but not limited to, vinyl sheeting. The plurality of legs 101 can be formed from molded plastic commercially available square tubing. Suitable plastics include, but are not limited to, polyethylene or polypropylene. Commercially available square tubing can be formed from steel or aluminum. The base can be brazed or welded into place. The top cap 102 can be formed from molded plastic or sheet metal. Suitable plastics include, but are not limited to, polyethylene or polypropylene. Commercially available snaps and cotter pins were used.

The following definitions were used in this disclosure:

Bush: As used in this disclosure, a bush is an individual low plant, or cluster of low plants, with a dense branch structure. By low is meant that a bush will not grow to the height of a tree. In this disclosure, shrub is considered to be a synonym for bush.

Flap: As used in this disclosure, a flap is a piece of material that is hinged or otherwise attached to a surface using one side such that the piece of material hangs in such a way as to cover a hole in the surface.

Sheeting: As used in this disclosure, sheeting is a material, such as cloth or plastic, in the form of a thin flexible layer or layers that is used to cover something.

Snap: As used in this disclosure, a snap is a fastener that comprises a male component and a female component. The snap is engaged by pressing the male component in to the female component.

With respect to the above description, it is to be realized that the optimum dimensional relationship for the various components of the invention described above and in FIGS. 1 through 5, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A protective cover comprising:
a plurality of legs, a top cap, and a plurality of sides;
wherein the protective cover is adapted for use with a bush;
wherein the protective cover is adapted to protect the bush from harsh weather conditions.

2. The protective cover according to claim 1 wherein each of the plurality of legs is formed from a plurality of telescopic tubes.

3. The protective cover according to claim 2 wherein each individual telescopic tube is shaped in the form of a hollow rectangular block.

4. The protective cover according to claim 3 wherein the plurality of telescopic tubes are formed so that the plurality of telescopic tubes can be nested into a telescopic arrangement.

5. The protective cover according to claim 4 wherein each individual telescopic tube is formed with a seventeenth plurality of holes.

6. The protective cover according to claim 5 wherein the length of each of the plurality of legs is set using an one or more cotter pins.

7. The protective cover according to claim 6 wherein each of the individual telescopic tube has attached to it an eighteenth plurality of female snap components and a nineteenth plurality of female snap components.

8. The protective cover according to claim 7 wherein each of the plurality of legs has attached to it an anchor plate.

9. The protective cover according to claim 4 wherein the top cap is formed from a plate;
wherein a twenty fourth plurality of holes are formed through the two largest surfaces of the plate.

10. The protective cover according to claim 9 wherein the top cap is formed with a twenty fifth side channel and a twenty sixth side channel.

11. The protective cover according to claim 10 wherein the perimeter of the surface of the top cap distal from the ground is formed with a twenty seventh lip.

12. The protective cover according to claim 11 wherein the surface of the top cap that is proximal to the ground is formed with a twenty eighth plurality of leg posts.

13. The protective cover according to claim 12 wherein each of the twenty eighth plurality of leg posts is sized to receive a leg selected from the plurality of legs.

14. The protective cover according to claim 13 wherein each of the plurality of sides is made from plastic sheeting.

15. The protective cover according to claim 14 wherein each of the plurality of sides is formed with a plurality of wind flaps.

16. The protective cover according to claim 15 wherein each of the plurality of sides has attached to it a twentieth plurality of male snap components and a twenty first plurality of male snap components.

17. The protective cover according to claim 16 wherein
the twentieth plurality of male snap components snap into a female snap component selected from the eighteenth plurality of female snap components;
wherein the twenty first plurality of male snap components snap into a female snap component selected from the nineteenth plurality of female snap components.

18. The protective cover according to claim 17 wherein the plurality of sides further comprises a first side, a second side, a third side and a fourth side.

19. The protective cover according to claim 18 wherein
the plurality of legs further comprises a fifth leg, a sixth leg, a seventh leg and an eighth leg;
wherein the top cap further comprises a twenty ninth leg post, a thirtieth leg post, a thirty first leg post, and a thirty second leg post.

20. The protective cover according to claim 19 wherein
the first side is attached to the fifth leg and the sixth leg;
wherein the second side is attached to the sixth leg and the seventh leg;
wherein the third side is attached to the seventh leg and the eighth leg;
wherein the fourth side is attached to the eighth leg and the fifth leg.
